(19) United States
(12) Patent Application Publication
(10) Pub. No.: US 2008/0299427 A1
(43) Pub. Date: Dec. 4, 2008

(54) FUEL CELL DEVICE AND ELECTRONIC APPARATUS SYSTEM INCLUDING FUEL CELL DEVICE

(75) Inventor: Hideaki Tanaka, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/130,949

(22) Filed: May 30, 2008

(30) Foreign Application Priority Data
May 31, 2007 (JP) 2007-145796

(51) Int. Cl. H01M 8/04

(52) U.S. Cl. 429/23

(57) ABSTRACT

According to one embodiment, a fuel cell device includes an electromotive unit which has an anode and a cathode and generates electricity based on a chemical reaction, a fuel tank, a fuel flow path which flows fuel supplied from the fuel tank through the anode side, a gas flow path which circulates air sucked from a suction port through the cathode side and exhausts discharge gas generated in the electromotive unit from an exhaust port, a first sensor which detects the gas sucked from the suction port, a second sensor which detects the gas exhausted from the exhaust port, and a controller which compares the gas detected by the first sensor with the gas detected by the second sensor, calculates an amount of substances generated in the cell when power is generated, and controls a power generating operation of the electromotive unit according to a result of the calculation.

### CROSS-REFERENCE TO RELATED APPLICATIONS

This application is based upon and claims the benefit of priority from Japanese Patent Application No. 2007-145796, filed May 31, 2007, the entire contents of which are incorporated herein by reference.

### BACKGROUND

1. Field

One embodiment of the present invention relates to electronic apparatus and an electronic apparatus system including a fuel cell device for supplying a current thereto.

2. Description of the Related Art

At present, secondary cells such as lithium-ion batteries are mainly used as power sources for electronic apparatuses such as mobile notebook personal computers (hereinafter, referred to as notebook PCs), mobile apparatuses, and the like. Recently, compact fuel cells, which have a high output and need not be charged, are expected as new power sources in response to a request for increasing power consumption and use time as a result of sophisticated function of the electronic apparatus. Although fuel cells have various types, attention has been particularly paid to a fuel cell, which employs a direct methanol system (hereinafter, referred to as DMFC) using a methanol solution as fuel as a power supply of electronic apparatus because the methanol fuel can be handled more easily than the fuel of fuel cells using hydrogen.

Ordinarily, DMFC includes a fuel tank for storing methanol therein, a liquid feed pump for supplying methanol to an electromotive unit under pressure, and an air supply pump for supplying air to the electromotive unit, and the like. The electromotive unit includes a cell stack that is formed by stacking in layers a plurality of single cells each including an anode and a cathode. When methanol is supplied to the anode side and air is supplied to the cathode side, the electromotive unit generates electricity by a chemical reaction. Unreacted methanol and carbon dioxide gas are generated in the anode side and water is generated in the cathode side as reaction products resulting from power generation. The water as the reaction product is exhausted as steam.

The fuel cell having the above arrangement has been developed as a cell having clean exhaust gas. However, when a system of the fuel cell fails, it is considered that unreacted methanol and excessive carbon dioxide as well as formic acid, formaldehyde, and the like as intermediate products may be exhausted. When the fuel cell is continuously operated for a long period abnormally in a narrow space, it is feared that human bodies may be adversely affected thereby.

In general, a fuel cell is operated by optimally supplying fuel and optimally controlling a temperature while measuring the power generated thereby and the temperature of the cell stack so that exhaust gases described above are not discharged in an amount exceeding a regulated value. For example, Jpn. Pat. Appln. KOKAI Publication No. 2006-331907 proposes a fuel cell wherein a gas sensor is provided on the exhaust side thereof to detect reducing gas and an operation of the fuel cell is stopped when harmful exhaust gas is detected by the gas sensor.

According to the fuel cell arranged as described above, the reliability of operation of the fuel cell can be improved by detecting the exhaust gas by the sensor. However, it is considered that the outside air taken into the fuel cell contains various gases, for example, high concentration carbon dioxide, volatile gas generated from an aromatic substance, smoke of tobacco, and the like depending on a usage environment. In this case, it is difficult to discriminate whether the gas contained in the exhaust gas from the fuel cell is the gas generated by the drive operation of the fuel cell or the gas contained in the outside air. Accordingly, it is difficult to more properly operate the fuel cell only by detecting the exhaust gas.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing a portable computer according to a first embodiment of the invention;

FIG. 2 is an exemplary view schematically showing an internal structure of the portable computer and a fuel cell device;

FIG. 3 is an exemplary sectional view showing a cell stack of the fuel cell device;

FIG. 4 is an exemplary view schematically showing a single cell of the cell stack;

FIG. 5 is an exemplary flowchart showing a drive operation in response to a gas concentration of the fuel cell device; and

FIG. 6 is an exemplary view schematically showing a portable computer and a fuel cell device according to a second embodiment of the invention.

### DETAILED DESCRIPTION

Various embodiments according to the invention will be described hereinafter with reference to the accompanying drawings. In general, according to an embodiment of the invention, a fuel cell device comprises: an electromotive unit which has an anode and a cathode and generates power by chemical reaction; a fuel tank which accommodates fuel; a fuel flow path which causes the fuel supplied from the fuel tank to flow through the anode side of the electromotive unit; a gas flow path which has a suction port and an exhaust port and circulates air sucked from the suction port through the cathode side and exhausts discharge gas generated in the electromotive unit from the exhaust port; a first sensor which detects the gas sucked from the suction port; a second sensor which detects the gas exhausted from the exhaust port; and a controller which compares the gas detected by the first sensor with the gas detected by the second sensor, calculates an amount of substances generated in the cell when power is generated, and controls a power generating operation of the electromotive unit according to a result of the calculation.

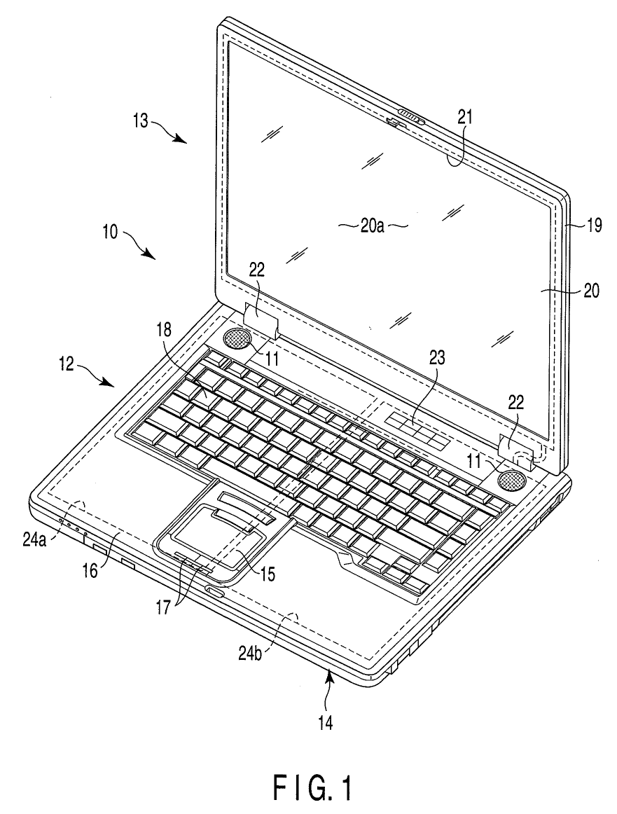

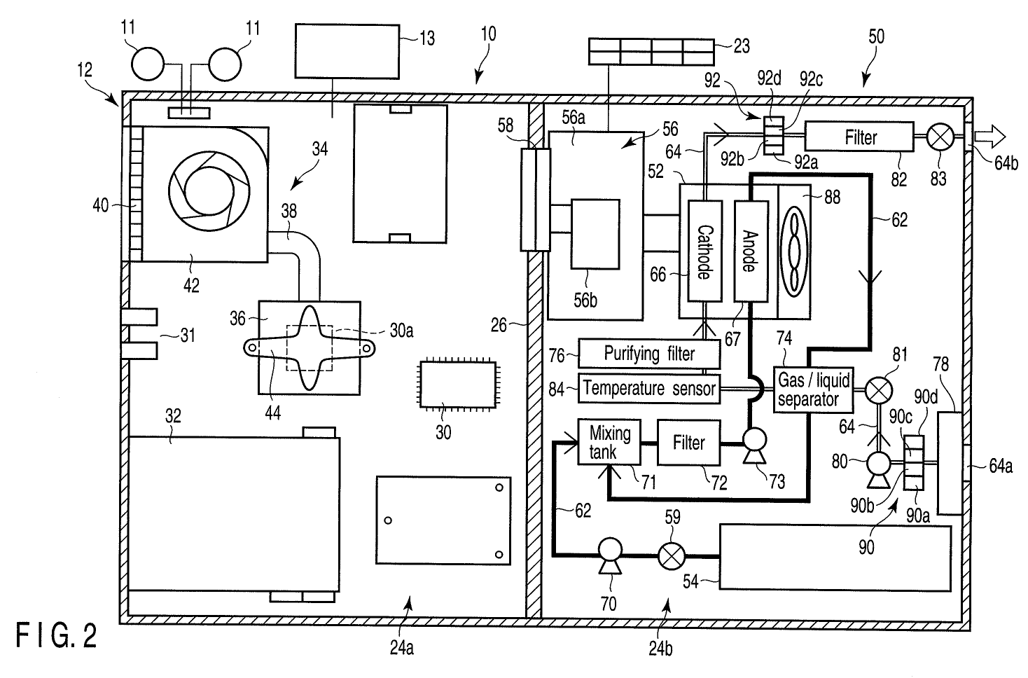

FIG. 1 shows a portable computer including a fuel cell device as an electronic apparatus system according to a first embodiment of the invention, and FIG. 2 schematically shows an internal structure of the portable computer.

As shown in FIG. 1, a portable computer 10 includes an apparatus main body 12, and a display unit 13 supported by the apparatus main body 12. The apparatus main body 12 includes a flat rectangular housing 14 formed of, for example, synthetic resin. A palm rest portion 16 is formed on the upper surface of the housing 14, and a touch pad 15 and click buttons 17 are disposed at approximately the center of the palm rest portion. A keyboard 18 is provided on the rear side of the palm rest portion 16. Speakers 11 are arranged at the right and left portions of the rear end of the upper surface of the housing 14 and expose from the upper surface, respectively. On the rear end portion of the upper surface of the housing 14 are provided a plurality of LEDs 23 which indicate the operating states of the portable computer and the fuel cell device described later.

The display unit 13 as a display portion includes a flat rectangular box-shaped housing 19 and a liquid crystal display panel 20 accommodated in the housing. A display surface 20a of the liquid crystal display panel 20 is exposed to the outside through a display window 21 formed in the housing 19. The housing 19 is rotatably supported on the rear end of the housing 14 by a pair of hinge portions 22 which are provided at the rear end of the housing 14. With this arrangement, the display unit 13 is rotatable between a closed position, at which it is closed so as to cover the keyboard 18 from above, and an open position at which it stands rearward of the keyboard.

As shown in FIGS. 1 and 2, the housing 14 includes an electronic apparatus region 24a and a fuel cell region 24b in the inside thereof, and these regions are partitioned by a partition wall 26 disposed in the housing 14. The electronic apparatus region 24a and the fuel cell region 24b are formed in, for example, an approximately the same size, and defined on the right and left sides across the partition wall 26.

Various components which constitute the portable computer 10 as an electronic apparatus are disposed in the electronic apparatus region 24a. A printed circuit board 28 constituting a mother board, for example, is arranged in the electronic apparatus region 24a. A plurality of semiconductor devices 30 including an MPU 30a, a modem substrate, a modem connector 31, a USB substrate, and various other electronic parts are mounted on the printed circuit board 28.

A hard disk drive 32 as a storage unit, for example, is disposed in the electronic apparatus region 24a as well as a radiation mechanism 34 is disposed therein to cool the MPU 30a as a heat generation member. The radiation mechanism 34 includes a radiation plate (heat block) 36, a heat pipe 38, a heat radiation fin 40, and a cooling fan 42.

The radiation plate 36 is formed of metal having a high heat conductivity, for example, aluminum and the like and formed in an approximately rectangular shape. The radiation plate 36 is formed sufficiently larger than the plane area of the MPU 30a. The radiation plate 36 is overlapped on the MPU 30a through a heat transfer sheet (not shown) and thermally connected to the MPU 30a. The radiation plate 36 is fixed to the printed circuit board 28 by a metal leaf spring 44 and elastically pressed against the MPU 30a.

The radiation plate 36 is thermally connected to the radiation fin 40 through the heat pipe 38. The radiation fin 40 is disposed adjacent to a side wall of the housing 14 and confronts it. The radiation fin 40 is arranged in an opening formed to the side wall of the housing 14 and faces to the cooling fan 42.

When the MPU 30a generates heat by the operation of the portable computer 10, the heat is received by the radiation plate 36. With this operation, the MPU 30a is cooled. The heat of the radiation plate 36 is transferred to the radiation fin 40 through the heat pipe 38. Further, when the cooling fan 42 is operated, cooling air is blown from an exhaust port of the cooling fan to the radiation fin 40. With this operation, the heat transferred to the radiation fin 40 is radiated from the radiation fin and radiated to the outside of the housing 14 through the opening.

As shown in FIG. 2, a fuel cell device 50 is disposed in the fuel cell region 24b. The fuel cell device 50 is configured as DMFC using methanol liquid fuel. The fuel cell device 50 includes a cell stack 52 constituting an electromotive unit, a fuel tank 54, a circulation system 60 for supplying fuel and air to the cell stack, and a cell controller 56 for controlling the entire operation of the fuel cell device. The cell controller 56 has a circuit board 56a and a microcomputer (CPU) 56b, and the circuit substrate 56a is connected to the printed circuit board 28 on the computer side through an interface 58. The interface 58 includes a power supply line, which supplies power from the fuel cell device 50 to the computer 10, and a communication line which transmits and receives a signal between the computer and the microcomputer of the fuel cell device.

The fuel tank 54 has a hermetically sealed structure, and high concentration methanol for use as liquid fuel is contained therein. The fuel tank 54 may be formed as a fuel cartridge which can be detachably mounted on the fuel cell device 50.

The circulation system 60 includes an anode channel (fuel channel) 62, which circulates the fuel supplied from a fuel supply port of the fuel tank 54 through the cell stack 52, a cathode channel (gas channel) 64, which circulates gases containing air through the cell stack 52, and a plurality of auxiliary units disposed in the anode channel 62 and the cathode channel 64. The anode channel 62 and the cathode channel 64 are formed of pipings and the like, respectively.

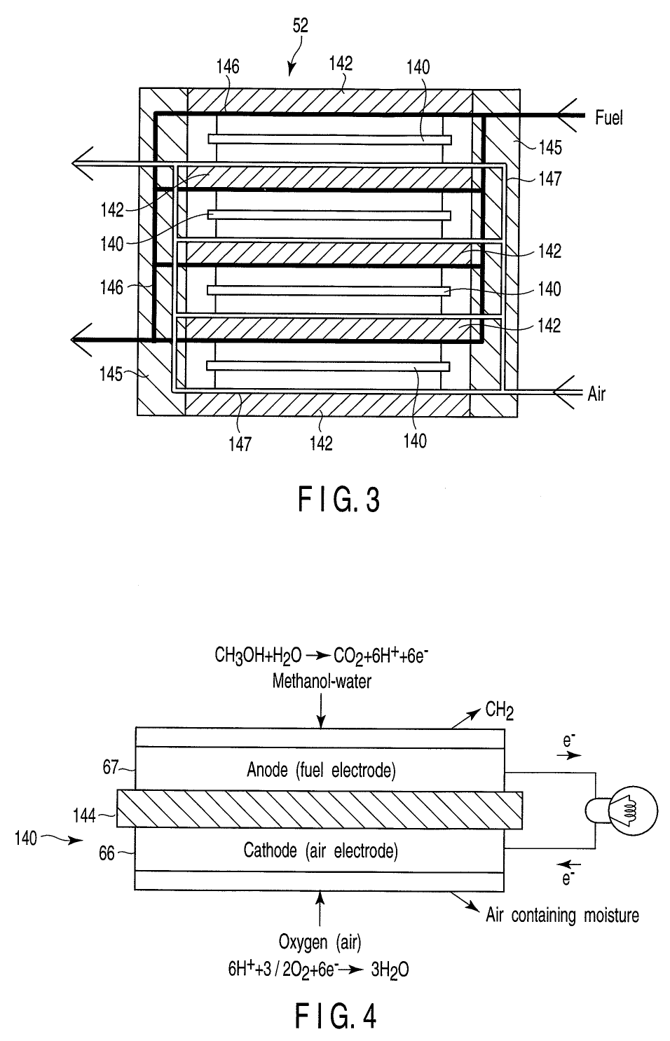

FIG. 3 shows a stack structure of the cell stack 52, and FIG. 4 schematically shows the power generating reaction of respective cells. As shown in FIGS. 3 and 4, the cell stack 52 has a stack member, and a frame member 145 for supporting the stack member. The stack member includes a plurality of single cells 140, for example, four single cells 140 and five rectangular-sheet-shaped separators 142 stacked alternately. Each single cell 140 has a membrane electrode assembly (MEA) in which a cathode (air electrode) 66, an anode (fuel electrode) 67, and an approximately rectangular polymer electrolyte membrane 144 are integrally arranged. Each of the cathode 66 and the anode 67 is formed of a catalyst layer and carbon paper and has an approximately rectangular sheet shape, and the electrolyte membrane 144 is sandwiched between the cathode and the anode. The polymer electrolyte membrane 144 is formed in an area larger than that of the anode 67 and the cathode 66.

Three separators 142 are stacked between two adjacent single cells 140, and the other two separators are stacked on both the ends in a stack direction, respectively. A fuel flow path 146 for supplying fuel to the anode 67 of each single cell 140 and an air flow path 147 for supplying air to the cathode 66 of each single cell are formed in the separators 142 and the frame member 145.

As shown in FIG. 4, the supplied fuel and air are chemically reacted with the electrolyte membrane 144 interposed between the anode 67 and the cathode 66, thereby electricity is generated between the anode and the cathode. The power generated in the cell stack 52 is supplied to the portable computer 10 through the cell controller 56.

As shown in FIG. 2, a cooling fan 88 is disposed in confrontation with the cell stack 52. When the cooling fan 88 rotates, it blows cooling air to the cell stack 52 and cools it. The cell stack 52 generates heat by the power generating operation thereof and acts as a heating element having a temperature of about 50 to 70° C. The temperature of the cell stack 52 can be controlled to a proper operating temperature by adjusting the cooling air by controlling the number of revolutions of the cooling fan 88. Note that a plurality of radiation fins may be disposed to the cell stack 52 to enhance the radiation therefrom.

An auxiliary unit disposed to the anode channel 62 includes an opening/closing valve 59 connected to a fuel supply port of the fuel tank 54, a fuel pump 70, and a mixing tank 71 connected to an output of the fuel pump through a piping. Further, the auxiliary unit has a liquid feed pump 73 connected to the output of the mixing tank 71 constituting a portion of the fuel tank 54 through a liquid filter 72. An output of the liquid feed pump 73 is connected to the fuel flow path 146 of the cell stack 52 through the anode channel 62.

An output of the anode 67 of the cell stack 52 is connected to an input of the mixing tank 71 through the anode channel 62. A gas/liquid separator 74 is disposed to the anode channel 62 between an output of the cell stack 52 and the mixing tank 71. The fluid discharged from the anode 67 of the cell stack 52, that is, a gas/liquid two-phase flow containing an unreacted aqueous methanol solution which is not used in the chemical reaction and carbon dioxide (CO₂) generated by the chemical reaction, is supplied to the gas/liquid separator 74 and the carbon dioxide is separated therein. The separated aqueous methanol solution is returned to the mixing tank 71 through the anode channel 62 and fed to the anode 67 again. The carbon dioxide separated by the gas/liquid separator 74 is supplied to a gas purifying filter 76 to be described later through the cathode channel 64.

A suction port 64a and an exhaust port 64b of the cathode channel 64 communicate with the atmosphere through a side wall of the housing 14, respectively. An auxiliary unit disposed to the cathode channel 64 includes an air filter 78, which is disposed in the vicinity of the suction port 64a of the cathode channel 64 upstream of the cell stack 52, a first gas sensor 90, an air supply pump 80, which is connected to the cathode channel between the cell stack 52 and the first gas sensor, an opening/closing valve 81, a second gas sensor 92, which is interposed between the cell stack 52 and the exhaust port 64b downstream of the cell stack, an exhaust filter 82, and an opening/closing valve 83. Further, a temperature sensor 84 and the gas purifying filter 76 are disposed to the cathode channel 64 between the opening/closing valve 81 and the cell stack 52.

The air filter 78 provided at the suction port 64a captures and removes dusts in the air sucked into the cathode channel 64 and impurities, harmful substances and the like such as carbon dioxide, formic acid, fuel gas, formic acid methyl, and formaldehyde. The exhaust filter 82 makes the byproducts in the gas exhausted from the cathode channel 64 to the outside harmless as well as captures fuel gas and the like contained in the exhaust gas.

The first gas sensor 90 arranged on the suction port 64a side includes, for example, a CO₂ concentration sensor 90a for detecting a CO₂ concentration in sucked air, a methanol concentration sensor 90b for detecting a methanol concentration, a formaldehyde concentration sensor 90c for detecting a formaldehyde concentration, and a formic acid concentration sensor 90d for detecting a formic acid concentration.

The second gas sensor 92 disposed to the exhaust port 64b includes at least one type of the same sensor as the first gas sensor. Here, the second gas sensor 92 includes a CO₂ concentration sensor 92a for detecting a CO₂ concentration in exhaust gas, a methanol concentration sensor 92b for detecting a methanol concentration, a formaldehyde concentration sensor 92c for detecting a formaldehyde concentration, and a formic acid concentration sensor 92d for detecting a formic acid concentration.

The first gas sensor 90 and the second gas sensor 92 output the gas concentrations detected thereby to the cell controller 56, respectively. The gas/liquid separator 74 is connected to the cathode channel 64 between the flow-in side of the cell stack 52 and the opening/closing valve 83. Further, the temperature sensor 84 is provided at the cathode channel 64 between the gas/liquid separator 74 and the flow-in side of the cell stack 52.

When the portable computer 10 is operated using the fuel cell device 50 constructed as described above as a power supply, the fuel pump 70, the liquid feed pump 73, and the air supply pump 80 are operated under the control of the cell controller 56 as well as the opening/closing valves 59, 81, and 83 are opened. Methanol is supplied from the fuel tank 54 to the mixing tank 71 by the fuel pump 70 and mixed with water in the mixing tank, thereby a aqueous methanol solution having a desired concentration is formed. Further, the aqueous methanol solution in the mixing tank is supplied to the anode 67 of the cell stack 52 through the anode channel 62 by the liquid feed pump 73.

Outside air, that is, air is sucked into the cathode channel 64 from the suction port 64a thereof by the air supply pump 80. The air passes through the air filter 78, in which dusts and impurities in the air are removed by the air filter. After the air passes through the air filter 78, it passes through the first gas sensor 90 in which the concentrations of CO₂, methanol, formaldehyde, and formic acid contained in the air are detected, respectively. The air is supplied to the gas/liquid separator 74 passing through the cathode channel 64 and further supplied to the cathode 66 of the cell stack 52 together with the exhaust gas separated by the gas/liquid separator and exhausted from the cell stack 52.

The methanol and the air supplied to the cell stack 52 is subjected to electrochemical reaction by the electrolyte membrane 144 interposed between the anode 67 and the cathode 66, thereby electricity is generated between the anode 67 and the cathode 66. The power generated in the cell stack 52 is supplied to a computer main body through the cell controller 56.

As a result of the electrochemical reaction, carbon dioxide is generated on the anode 67 side and water is generated on the cathode 66 side in the cell stack 52 as reaction products. The carbon dioxide generated on the anode 67 side and the unreacted aqueous methanol solution which is not used in the chemical reaction are supplied to the gas/liquid separator 74 through the anode channel 62 and separated to carbon dioxide and a aqueous methanol solution therein. The separated aqueous methanol solution is collected to the mixing tank 71 from the gas/liquid separator 74 through the anode channel 62 and used again for power generation.

The separated carbon dioxide is supplied from the gas/liquid separator 74 to the cathode channel 64 and further supplied to the gas purifying filter 76 together with air. After impurities in the air and harmful substances containing the carbon dioxide are removed by the gas purifying filter 76, the air and the carbon dioxide are supplied to the cell stack 52 and used for power generation. With this operation, the impurities in the air are prevented from being supplied to the cell stack 52, thereby preventing deterioration of a power generation efficiency caused by these impurities.

Almost all the water generated on the cathode 66 side of the cell stack 52 is turned into moisture vapor and discharged to the cathode channel 64 together with the air. The concentrations of CO₂, methanol, formaldehyde, and formic acid contained in gases containing the discharged air and moisture vapor are detected by the second gas sensor 92, respectively. Thereafter, the discharged gases are supplied to the exhaust filter 82. After dusts and impurities are removed from the gases by the exhaust filter 82, the gases are exhausted from the exhaust port 64b of the cathode channel 64 to the outside.

During the power generating operation described above, the cell controller 56 monitors the states of the gases on the suction side detected by the first gas sensor 90 and the states of the gases on the exhaust side detected by the second gas sensor 92, calculates the amount of substances generated in the power generation performed in the fuel cell, and controls the fuel cell device to an optimum operating state according to a result of the calculation. More specifically, when the gases generated in the device adversely affect a power generating operation and the health of a user, the cell controller 56 feeds back the result of the calculation to a system control and improves gas components by changing a method of operating the fuel cell. Further, when gas components cannot be improved by controlling the operation, the cell controller 56 issues an alarm (sound and display by LED) to the user and automatically stops the system depending on conditions.

For example, the cell controller 56 determines the power generating state and the amount of crossover of the fuel cell device 50 making use of the data detected by the CO₂ concentration sensors 90a, 92b on the suction and exhaust sides and performs the power generating operation in a proper state by changing the operating temperature of the cell stack 52 and the amount of fuel to be supplied.

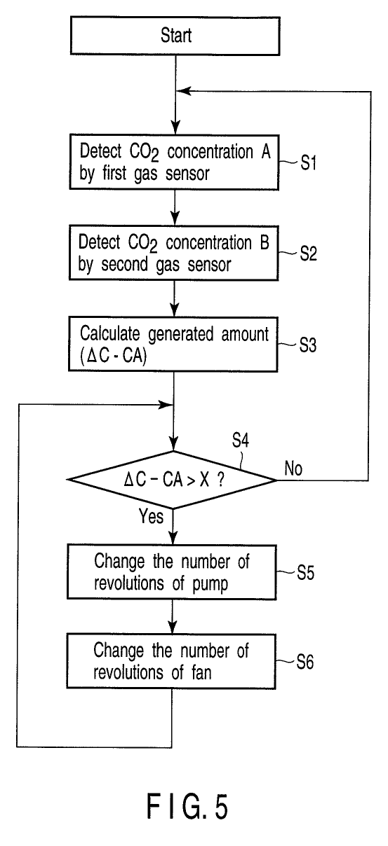

CO₂ is contained in the atmosphere in the amount of about 380 ppm, and the concentration thereof is increased in a narrow room by the breath of a person and the CO₂ generated by the fuel cell device 50. To cope with the above problem, the CO₂ concentration of the atmospheric air sucked by the fuel cell device 50 is measured by the suction side CO₂ concentration sensor 90a (S1), and further the CO₂ concentration of the exhaust gases exhausted from the cell stack 52 is measured by the CO₂ concentration sensor 92a (S2) as shown in FIG. 5. Then, the amount of CO₂ generated in the fuel cell device is determined by calculating the difference between the measured CO₂ concentrations (S3).

The following expression is established when a concentration difference is shown by ΔC (ppm), the amount of an exhausted gas flow is shown by Vout (L/min), and the amount of CO₂ generated per minute is shown by ΔM: VoutΔC=ΔM

CO₂ is also generated on the cathode 66 side by the methanol which passes through the electrolyte membrane and is reacted with a catalyst, in addition to the CO₂ (CH₃OH+H₂O→CO₂+6H+6e⁻¹) generated by the reaction on the anode 67 side of the cell stack 52. This phenomenon is referred to as so-called crossover by which the power generation efficiency of the system is deteriorated.

The amount of CO₂ generated per minute in an ordinary reaction is shown by the following expression.

methanol consumed in power generation: Ngen[mol/min]

Ngen=I/F/6×n×60

Ngen=Vout×concentration of CO₂ generated by anode×(22.4×(273.15+Tout)/273.15)

I: generated current [A]

F: Faraday constant (=96485) [C/mol]

n: number of stack cells [sheet]

Tout: exhaust temperature [degree]

CA: concentration of CO₂ generated by anode=(I/F/6×n×60)/Vout(22.4×(273.15+Tout)/273.15)

ΔC-CA shows the concentration of CO₂ generated from the cathode.

When the CO₂ concentration exceeds a regulated value, since a large amount of crossover is generated, it is determined that the power generation efficiency is deteriorated.

The cell controller 56 compares the concentration of the generated CO₂ with a previously set predetermined value (S4), and when the concentration of the generated CO₂ exceeds the predetermined value, the cell controller 56 changes the number of revolutions of the liquid feed pump 73 for supplying fuel to the cell stack 52 and the number of revolutions of the air supply pump 80 for supplying air thereto, that is, reduces the numbers of revolutions of them here to control the amount of fuel to be supplied (S5). Otherwise, the cell controller 56 changes the number of revolutions of the cooling fan 88 for cooling the cell stack 52, that is, increases the number of revolutions here to control the operating temperature of the cell stack (S6). With this operation, the amount of crossover is reduced thereby the power generation efficiency is set to a proper efficiency.

Further, the cell controller 56 detects the concentration of formic acid as the intermediate product generated during the power generating operation. More specifically, the cell controller 56 detects the concentrations of the formic acid on the suction side and the exhaust side by the formic acid concentration sensors 90d and 92d and calculates the concentration of the formic acid generated in the fuel cell device 50 from the difference between the concentrations. Then, when the concentration of the generated formic acid exceeds a predetermined value and is abnormal, the cell controller 56 increases the operating temperature of the cell stack 52 by, for example, reducing the number of revolutions of the cooling fan 88 to thereby suppress generation of the intermediate product.

Further, when the concentration of a substance, to which attention is paid on the suction and exhaust sides, becomes abnormal and may adversely affect the system or the health of the user, the cell controller 56 issues an alarm to the user as well as stops the operation of the fuel cell device 50. For example, the cell controller 56 detects the methanol concentrations and the formaldehyde concentrations on the suction side and the exhaust side by the methanol concentration sensors 90b, 92b and the formaldehyde concentration sensors 90c, 92c and calculates the concentration of the methanol gas and the concentration of the formaldehyde generated in the fuel cell device by comparing the above concentrations. Then, when the cell controller 56 determines that at least one of the methanol concentration and the formaldehyde concentration exceeds a predetermined concentration and is made to an abnormal concentration, the cell controller 56 changes the color of the LEDs 23 or blinks them and at the same time generates an alarm sound from the speakers 11. Further, the cell controller 56 may display a substance and a concentration on the display unit 13 of the computer 10 and may display an alarm to the user thereon. The alarm display includes, for example, “turn off power supply”, “reduce concentration by opening window”, and the like. Further, the cell controller 56 may automatically stop the operation of the fuel cell device 50 simultaneously with the alarm described above.

According to the portable computer arranged as described above, the cell controller 56 can accurately discriminate the gases generated by the power generating operation of the fuel cell device and can realize a stable drive operation by comparing the states of the gases on the suction and exhaust sides and feeding back a result of the discrimination to the system control. The cell controller 56 can prevent an adverse affect on the health of the user by monitoring harmful exhausted substances by the gas sensors. With this arrangement, the fuel cell device and the electronic apparatus system whose reliability and safety are improved can be obtained.

Although the fuel cell device is built in the electronic apparatus in the first embodiment described above, it may be arranged independently of the electronic apparatus.

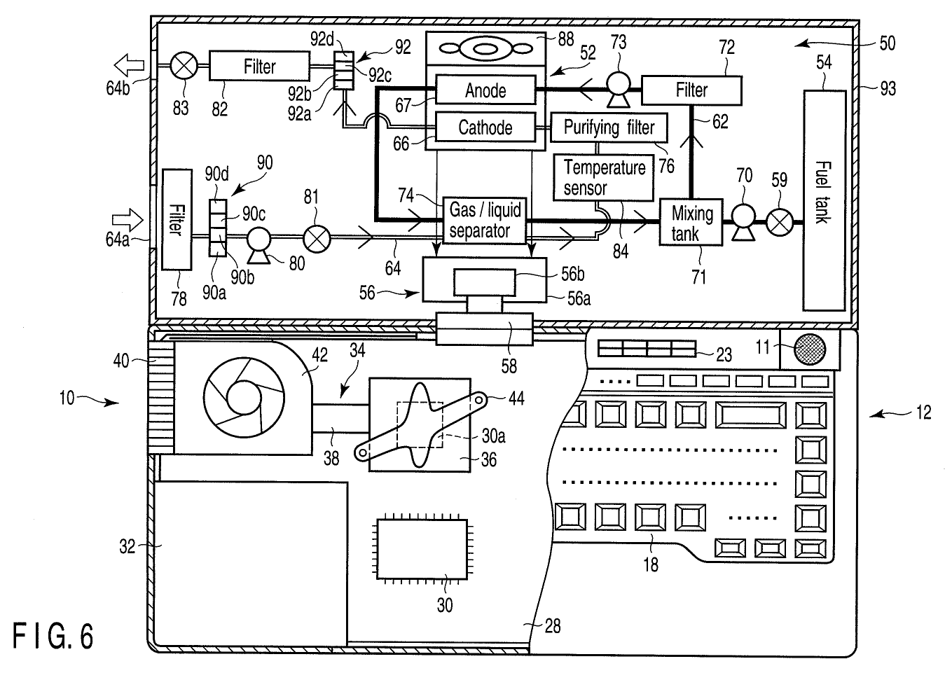

FIG. 6 shows an electronic apparatus system according to a second embodiment of the invention. According to the second embodiment, the electronic apparatus system includes a portable computer 10 and a fuel cell device 50 for supplying a current thereto. The fuel cell device 50 is disposed to the outside of an apparatus main body 12 of the portable computer 10 and is detachably connected to a rear portion of a housing 14. The fuel cell device 50 is electrically connected to the computer 10 through an interface connector 58.

Various components of the portable computer 10 are disposed in the housing 14 of the apparatus main body 12. That is, a printed circuit board 28 is disposed in the housing 14. A plurality of semiconductor devices 30 including an MPU 30, a modem substrate, a modem connector, a USB boards and other various electronic parts are mounted on the printed circuit board 28. Further, a hard disc drive 32, for example, is disposed in the housing 14 as a storage unit as well as a radiation mechanism 34 is also disposed therein to cool the MPU 30a.

A keyboard 18, speakers 11, and LEDs 23 are disposed on the upper surface of the housing 14. Further, a display unit (not shown) is disposed to the housing 14. The arrangement of the portable computer 10 is the same as that of the first embodiment described above, and the same portions are denoted by the same reference numerals and the detailed description thereof is omitted.

The fuel cell device 50 is arranged as DMFC using methanol as liquid fuel. The fuel cell device 50 has an approximately rectangular box-shaped housing 93. A cell stack 52 constituting an electromotive unit, a fuel tank 54, a circulation system 60 for supplying fuel and air to the cell stack, and a cell controller 56 for controlling the operation of the fuel cell device in its entirety are disposed in the housing 93. The cell stack 52 is constructed by stacking a plurality of single cells each having an anode 67, a cathode 66, and an electrolyte membrane (not shown).

The fuel tank 54 has a hermetically sealed structure, and high concentration methanol as liquid fuel is contained therein. The fuel tank 54 may be formed as a fuel cartridge which can be detachably mounted on the fuel cell device 50.

The circulation system 60 includes an anode channel (fuel flow path) 62, which circulates the fuel supplied from a fuel supply port of the fuel tank 54 through the cell stack 52, a cathode channel (air flow path) 64, which circulates gases containing air through the cell stack 52, and a plurality of auxiliary units disposed in the anode channel 62 and the cathode channel 64. The anode channel 62 and the cathode channel 64 are formed of pipings and the like, respectively.

A suction port 64a and an exhaust port 64b of the cathode channel 64 communicate with the atmosphere through a side wall of the housing 93, respectively. An auxiliary unit disposed to the cathode channel 64 includes a first gas sensor 90, which is disposed in the vicinity of the suction port 64a of the cathode channel 64 upstream of the cell stack 52, and a second gas sensor 92 which is interposed between the cell stack 52 and the exhaust port 64b downstream of the cell stack. The first gas sensor 90 disposed to the suction port 64a side includes, for example, a CO₂ concentration sensor 90a for detecting a CO₂ concentration in sucked air, a methanol concentration sensor 90b for detecting a methanol concentration, a formaldehyde concentration sensor 90c for detecting a formaldehyde concentration, and a formic acid concentration sensor 90d for detecting a formic acid concentration.

The second gas sensor 92 disposed to the exhaust port 64b includes at least one type of the same sensors as those of the first gas sensor. The second gas sensor 92 includes a CO₂ concentration sensor 92a for detecting the CO₂ concentration in exhaust gases, a methanol concentration sensor 92b for detecting a methanol concentration, a formaldehyde concentration sensor 92c for detecting a formaldehyde concentration, and a formic acid concentration sensor 92d for detecting a formic acid concentration. The first and second gas sensors 90, 92 output the gas concentrations detected thereby to the cell controller 56, respectively.

In the second embodiment, the other arrangement of the fuel cell device 50 is the same as that of the first embodiment described above, and the same portions are denoted by the same reference numerals and the detailed explanation thereof is omitted.

There can be also obtained the fuel cell device and the electronic apparatus system which can accurately determine the gases generated due to the drive operation of the fuel cell, can realize a more stable drive operation, and has improved reliability and safety also in the second embodiment having the above arrangement likewise the first embodiment.

While certain embodiments of the inventions have been described, these embodiments have been presented by way of example only, and are not intended to limit the scope of the inventions. Indeed, the novel methods and systems described herein may be embodied in a variety of other forms. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The gases detected on the suction and exhaust sides are not limited to those described in the above embodiments, and the other gases such as formic acid methyl may be detected. The electronic apparatus system to which the present invention is applied is not limited to the portable computer and may be other electronic apparatus. The type of the fuel cell is not limited to DMFC and other types such as PEFC (Polymer Electrolyte Fuel Cell) may be employed.

What is claimed is:

1. A fuel cell device comprising:
an electromotive unit comprising an anode and a cathode and configured to generate electricity from a chemical reaction;
a fuel tank configured to store fuel;
a fuel flow path configured to cause the fuel supplied from the fuel tank to flow through the anode side of the electromotive unit;
a gas flow path comprising a suction port and an exhaust port and configured to circulate air sucked from the suction port through the cathode side and to exhaust discharge gas generated in the electromotive unit from the exhaust port;
a first sensor configured to detect the gas sucked from the suction port;
a second sensor configured to detect the gas exhausted from the exhaust port; and
a controller configured to compare the gas detected by the first sensor with the gas detected by the second sensor, to calculate the amount of substances generated in the cell when power is generated, and to control a power generating operation of the electromotive unit based on the result of the calculation.

2. The fuel cell device of claim 1, wherein each of the first sensor and second sensor comprises a CO₂ concentration sensor configured to detect CO₂ concentration, and wherein the controller is configured to control at least one of the operating temperature of the electromotive unit and the amount of fuel to be supplied according to the concentration of the CO₂ generated in the cell.

3. The fuel cell device of claim 2, further comprising: a liquid feed pump configured to supply fuel to the electromotive unit; an air supply pump configured to supply air to the electromotive unit; and
a cooling fan configured to cool the electromotive unit, wherein the controller is configured to control the amount of fuel to be supplied by changing the number of revolutions of the liquid feed pump per unit time and to control the operating temperature of the electromotive unit by changing the number of revolutions of the cooling fan per unit time.

4. The fuel cell device of claim 1, wherein each of the first sensor and second sensor comprises at least one of a methanol concentration sensor configured to detect methanol concentration and a formaldehyde concentration sensor configured to detect formaldehyde concentration, and wherein the controller is configured to issue an alarm to a user by an alarm section or to stope the power generating operation when at least one of the calculated amounts of generation of formaldehyde and methanol exceeds a predetermined value.

5. The fuel cell device of claim 4, wherein the alarm section comprises at least one of an audio generator and a display unit.

6. The fuel cell device of claim 1, wherein each of the first sensor and second sensor comprises a concentration sensor configured to detect formic acid methyl concentration, and wherein the controller is configured to increase the operating temperature of the electromotive unit when the amount of generation of formic acid methyl exceeds a predetermined value.

7. An electronic apparatus system comprising:
an electronic apparatus having a housing and a display unit; and
a fuel cell device arranged in the housing,
the fuel cell device comprising: an electromotive unit comprise an anode and a cathode and generates electricity based on a chemical reaction; a fuel tank configured to store fuel; a fuel flow path which causes the fuel supplied from the fuel tank to flow through the anode side of the electromotive unit; a gas flow path comprising a suction port and an exhaust port and configured to circulate air sucked from the suction port through the cathode side and to exhaust discharge gas generated in the electromotive unit from the exhaust port; a first sensor configured to detect the gas sucked from the suction port; a second sensor configured to detect the gas exhausted from the exhaust port; and a controller configured to compare the gas detected by the first sensor with the gas detected by the second sensor, to calculate an amount of substances generated in the cell when power is generated, and to control a power generating operation of the electromotive unit according to a result of the calculation.

8. An electronic apparatus system comprising:
an electronic apparatus having a housing and a display unit; and
a fuel cell device which is detachably connected to the housing and is configured to supply power to the electronic apparatus,
the fuel cell device comprising: an electromotive unit comprising an anode and a cathode and configured to generate electricity based on a chemical reaction; a fuel tank configured to store fuel; a fuel flow path configured to cause the fuel supplied from the fuel tank to flow through the anode side of the electromotive unit; a gas flow path comprising a suction port and an exhaust port and configured to circulate air sucked from the suction port through the cathode side and exhausts discharge gas generated in the electromotive unit from the exhaust port; a first sensor configured to detect the gas sucked from the suction port; a second sensor configured to detect the gas exhausted from the exhaust port; and a controller configured to compare the gas detected by the first sensor with the gas detected by the second sensor, to calculate an amount of substances generated in the cell when power is generated, and to control a power generating operation of the electromotive unit according to a result of the calculation.
